(19) United States
(12) Patent Application Publication
(10) Pub. No.: US 2012/0323766 A1
(43) Pub. Date: Dec. 20, 2012

(54) METHOD FOR RECYCLING SCRAP

(76) Inventors: Robert Galindo, Commack, NY (US); Donald William Galindo, Commack, NY (US)

(21) Appl. No.: 13/163,688

(22) Filed: Jun. 18, 2011

(51) Int. Cl. G06Q 10/00; G06Q 40/00

(52) U.S. Cl. 705/39

(57) ABSTRACT

The present disclosure describes a method for the recycling of scrap that includes using a computer device with internet access to input data to a website of a recycling center. The input to the website includes data on the scrap, an originator of the scrap, container for the scrap and location of the scrap. The website limits the recycling of scrap to select types of scrap. The website uses the input data to calculate a potential value of the scrap. If the potential value of the scrap is acceptable, the website directs a commercial carrier to prepare a shipping label. The shipping label can be printed by the originator, attached to the scrap packaged in the container and transported by the commercial carrier from the location of the scrap to the location of the recycling center. The recycling center performs an actual valuation of the scrap upon receipt of the scrap and performs calculations as to the actual value of the scrap relative to the shipping costs to determine the payment to the originator and benefit to the recycling center.

### BACKGROUND OF THE INVENTION

1. Field of the Invention

The present disclosure relates to a method for recycling scrap and in particular to an internet based method for shipping scrap from an originator of the scrap to a recycling center.

2. Description of the Related Art

Local governments routinely collect many recyclable goods. In many instances, however, the owner of specialized higher value recyclable goods desires to be environmentally responsible and at the same time have the recycling of the specialized recyclable goods return a value. Specialized recyclable goods can include a broad range of categories of products that vary in weight, size and ability to be transported. Some of the most advantageous specialized recyclable goods include those of higher value, relatively small and lightweight. These specialized recyclable goods can be readily packaged and transported to the scrap facility. One category of specialized recyclable goods that is particularly attractive for recycling is electronic assemblies such as circuit boards, central processing units and other higher value components or assemblies. These specialized goods have the advantages of standard dimensions, relatively low weight and the potential for a relatively high scrap value.

Owners of specialized recyclable goods deal in a range from high to low quantities of those goods. The attractiveness of recycling these specialized recyclable goods in many instances is further reduced by unacceptably high transportation costs to the nearest recycling facility. This process can include the need to transport the recyclable goods over a sizable distance and under potentially difficult local traffic conditions to the nearest recycling facility. Further, upon arrival at the recycling facility, there can be an additional wait for the processing of the recyclable goods such as weighing and inspecting the goods to assess the scrap value before a payment for the specialized recyclable good is finally made by the recycling facility. The result can be a sizable time and money investment for a nominal return. Alternatives such as storing even relative small quantities of the specialized recyclable goods and requesting a pick-up of the material by the recycling center can also be economically unattractive. It is simply easier in many instances to throw the specialized recyclable goods into the garbage or have the specialized recyclable goods processed as generic recyclable goods without any return to the owner.

A method is needed that encourages owners to recycle limited quantities of specialized recyclable goods. The method needs to integrate a simplified internet based process for inputting data into a website on the recyclable material and coordinating the transportation for the specialized recyclable goods from a location of the originator to a location of the recycling center. The method further includes the recycling center providing an enhancement of environmental benefit through proper evaluation and handling of the specialized recyclable goods, recycling of the specialized recyclable goods and as appropriate a payment to the owner for the value of the specialized recyclable goods.

### SUMMARY OF THE INVENTION

The present disclosure describes a method for recycling scrap that comprises an originator of scrap using a computer device for inputting data into a website of a recycling center. The website performs calculations using data entered into the website on the scrap to determine whether the scrap meets shipping requirements and whether the potential value of the scrap is acceptable for recycling using the method for recycling scrap. When the potential value of the scrap is determined to be acceptable, the website coordinates shipping by a commercial carrier. Once the scrap arrives at the recycling center, an actual valuation of the scrap is performed and a payment forwarded to the originator.

The method includes the steps of inputting data on the originator of the scrap, scrap and a container. The website limits the inputting or entering of data on the scrap to one or more types of scrap material or scrap. The container provides packaging for the scrap during the transportation of the scrap by a commercial carrier.

The method includes calculating a potential value of the scrap data. The calculation of the potential value is performed using the scrap data and a cost of transporting the scrap from the commercial carrier. The website exchanges data with a website of the commercial carrier. The website makes a determination whether a potential value of the scrap data is acceptable. When the potential value of the scrap data is acceptable, the website authorizes a shipping label from the commercial carrier. The website coordinates the transfer of the shipping label to the originator.

The commercial carrier transports the packaged scrap in the container with the shipping label from a location of the scrap to a location of the recycling center. At the recycling center an actual valuation of the scrap is performed. The actual valuation of the scrap can include calculations that determine the payment for the scrap to the originator by the recycling center and the profitability for the recycling center. The calculations for the actual valuation of the scrap performed at the recycling center preferably use a local computer device that is independent of the website and the website process. Thus, the final phase of the method that includes the actual valuation of the scrap is performed independent of the initial website process.

The step of inputting data on the scrap into the website includes entering a weight and a quantity of each type of scrap. The step of calculating the potential value includes the website interfacing with a commercial carrier for the cost of transporting the scrap from the location of the scrap to the location of the recycling center and evaluating the cost of transporting the scrap relative to a potential value of the scrap. The calculating of the potential value can include the website automatically interfacing with a commercial carrier website for the cost of transporting the scrap.

The step of determining whether the potential value of the scrap data is acceptable can include not authorizing the preparation of a shipping label when the potential value of the scrap data is unacceptable. The step of performing an actual valuation includes identifying the one or more actual types of scrap, determining the actual quantity of scrap pieces and the actual weight of the one or more types of scrap and calculating the actual value of the scrap. The step of performing an actual valuation can include determining a benefit to the recycling center of the scrap by evaluating the cost of transporting the scrap to the recycling center relative to the actual value of the scrap. The step of inputting data on a container can include inputting the dimensions of the container. Alternatively, the inputting of data can include selecting one or more containers from a list of containers. The step of authorizing the shipping label includes sending notice to the recycling center of the authorizing of the shipping label.

The present disclosure also describes a method for shipping scrap from a location for recycling that includes the steps of using a computer device for inputting data into a website of a recycling center on an originator of scrap, scrap and a container. The data on the scrap includes a weight and a quantity of each type of scrap. The website limits the inputting of data to one or more defined types of scrap. The container provides packaging for the scrap during the transportation of the scrap from the location of the scrap to a location of the recycling center by a commercial carrier.

The method includes calculating a predicted value of the scrap data using the data input into the website on the scrap. The calculating of the predicted value of the scrap data is an initial determination to assess whether the scrap data supports a predicted value for the scrap that provides an acceptable benefit to the recycling center. The calculating of the predicted value can also include assessing whether the input scrap data is compatible with pre-defined shipping limitations. When the predicted value of the scrap is acceptable, the website acquires a cost for transporting the scrap from a website of the commercial carrier. The cost of transporting the scrap includes the cost of transporting the scrap by the commercial carrier from the location of the scrap to a location of the recycling center. The location of the scrap is included in the data input into the website. The location of the recycling center is pre-existing or stored data.

When the predicted value is acceptable, the website calculates a potential value of the scrap by evaluating the predicted value of the scrap relative to the cost of transporting the scrap. The website determines whether the calculated potential value of the scrap is an acceptable potential value for the recycling center. The website authorizes the commercial carrier to prepare a shipping label when the calculation of the potential value of the scrap is determined to have acceptable potential value for the recycling center. The website provides for the transfer of the shipping label to the originator by either making the shipping label accessible to the originator or transferring the shipping label to the originator.

The commercial carrier transports the scrap packaged in the container using the shipping label from the location of the scrap to a location of the recycling center. Once the scrap has arrived at the recycling center, an actual valuation of the scrap is performed that determines the actual value of the scrap to the recycling center. The actual value is then used by the recycling center to pay the originator for the scrap and determine the benefit to the recycling center.

The step of inputting data on the scrap can include inputting a quantity and a weight for each type of scrap of the one or more types of scrap that are acceptable to the website. The website identifies acceptable types of scrap for the originator. The step of inputting data on a container can include inputting the approximate dimensions of the container or alternatively identifying the container from a list of one or more standard containers of known dimensions. The step of calculating includes the website receiving a cost for transporting the scrap from a commercial carrier. The cost of transporting the scrap can include the website selecting a lowest cost commercial carrier from the two or more costs received by the website from a plurality of commercial carriers. The cost of transporting the scrap can include the website interfacing automatically with a single commercial carrier for the cost of transporting the scrap.

The step of authorizing the preparation of a shipping label includes sending notice to the recycling center of the authorizing of the shipping label. The authorizing the preparation of the shipping label can further include the notice to the recycling center initiating a security validation of the originator prior to the authorizing of the shipping label.

The inputting of data for the method of recycling scrap can further include the originator sending an image of the scrap to the website of the recycling center and/or the recycling center. In one preferred embodiment, the originator sends the image and requests an assessment of whether the scrap is acceptable for the method for recycling scrap prior to the input of the data into the website. The image can also be sent as part of the data input into the website. The image or images can be sent via any suitable form of data transfer to include electronic mail, for example, as one or more images taken by a camera in a cellular phone or a live audio and video transmission between computer devices. The digital image of the scrap is reviewed by the recycling center to determine whether the scrap is acceptable for inclusion in the method for recycling scrap and can also assist in the determination of the actual value of the scrap.

The present disclosure is preferably intended for use in a combined internet and locally based computing environment. In this regard, it is understood that while references are made to a website associated with the recycling center, a website associated with a commercial carrier, software associated with a computer device of an originator and software associated with a computer device of the recycling center, all of the above involve software executing in different program modules that can be physically located in different memory storage devices at different locations. The functions, processes and/or method disclosed between these computer devices/servers are carried out by software that is preferably executed on the respective servers for the websites and the computer programs of the computer device of the originator. All of the above servers and computer device are connected to the internet and either in communication of one another or capable of communicating between one another. It is also understood that the processes and methods presented herein can be arranged in differing sequences, be blended between one another or even in some instances omitted without changing the basic core of the present disclosure. Accordingly, it will also be understood that the term website as defined herein includes a sequence of computer-executed instructions that are integrated into program modules that define the steps that lead to a specified result. These instructions commonly require the physical manipulation of physical quantities in the form of electrical, magnetic or optical signals that are capable of being transferred, stored and manipulated. These manipulations within the computer environment are commonly referred to in terms of an algorithm that can include adding, comparing, assessing/contrasting of data or computations relative to a standard to achieve a result. References made herein to functions, performance of processes, steps or methods by the websites additionally involve the use of the servers and can further include other computer devices as well as additional software. Similarly, references to electronic communications encompasses analog as well digital communications whether electrical, magnetic or optical signals.

In addition, the present method involves calculations at the recycling center that can be performed on any computer, but are preferably performed locally on a computer at the recycling center. The computer of the recycling center preferably performs calculations as to the actual valuation of the scrap based on actual inspections/verifications of the type and quantity of pieces of scrap as well as actual measurement of the weight of the scrap. The calculated actual valuation of the scrap is then evaluated against the cost of commercial carrier transportation to determine the payment to the originator and benefit or profit for the recycling center. The payment is preferably forwarded by the recycling center via the postal service to the originator.

### BRIEF DESCRIPTION OF THE DRAWINGS

Preferred embodiments of the disclosure are described below with reference to the drawings, wherein like numerals are used to refer to the same or similar elements.

FIG. 1 is an idealized representation of a method for recycling scrap in accordance with the present disclosure;

FIG. 2 is a simplified process flow diagram illustrating the method for recycling scrap of FIG. 1 in accordance with the present disclosure; and

FIG. 3 is a simplified process flow diagram illustrating continuing the method for recycling scrap of FIG. 2.

### DETAILED DESCRIPTION OF THE INVENTION

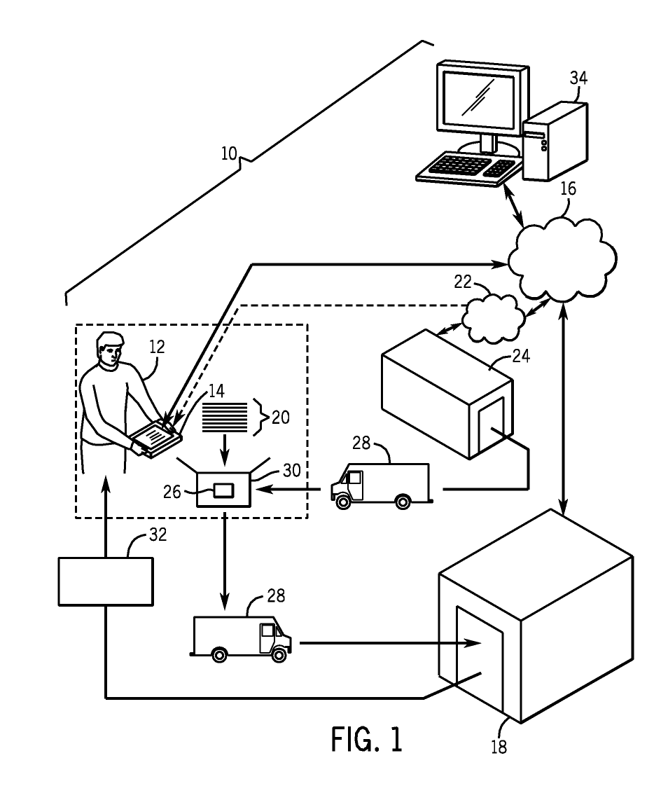

Referring initially to FIG. 1, the present disclosure relates to a method for the recycling of scrap 10. Method for recycling scrap 10 includes an originator 12 using a computer device 14 to access and input into a website 16 of a recycling center 18 data on originator 12 and scrap 20. Website 16 assesses the value of scrap material 20 using the data input by originator 12 and data from a website 22 of a commercial carrier 24. When the value of scrap 20 is acceptable, website 16 coordinates with commercial carrier website 22 for the production of a shipping label 26 and commercial carrier transportation 28 of scrap 20. Originator 12 accesses shipping label 26 and packages scrap 20 in a container 30. Commercial carrier transportation 28 ships scrap 20 in container 30 with shipping label 26 attached from the location of scrap 20 to recycling center 18. The method for recycling scrap 10 makes recycling more attractive to originators 12 that need to dispose of limited quantities of unwanted, but valuable scrap 20. Once the shipment is received by recycling center 18, the actual scrap material 20 is assessed and a payment 32 is forwarded by recycling center 18 to originator 12.

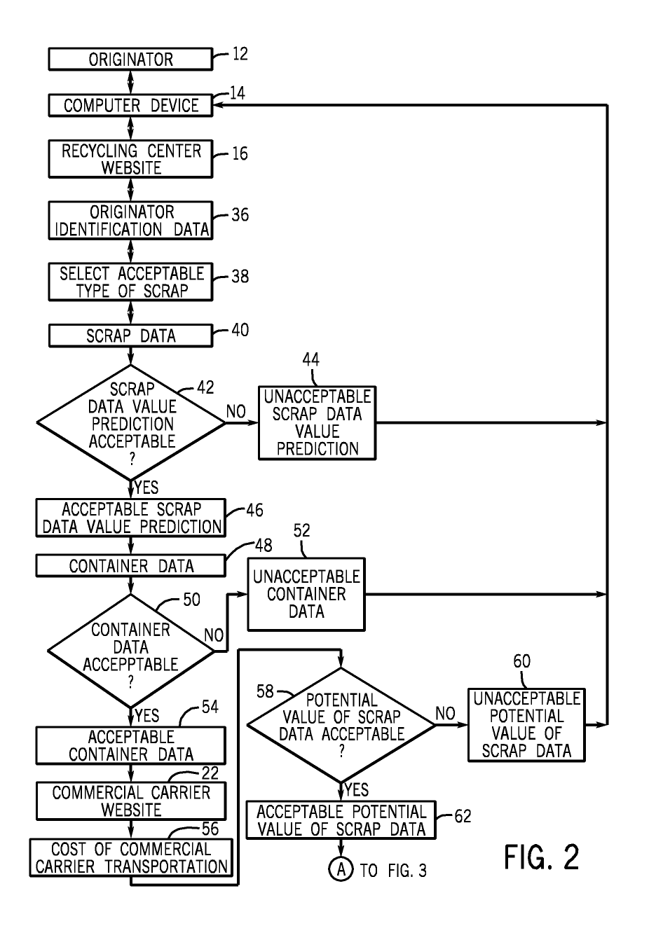

As shown in FIGS. 1 and 2, originator 12 is a source or seller of scrap 20 that can be an individual or an entity that is for example a small business, governmental agency, non-profit corporation or an industrial/commercial facility. As defined herein, originator 12 can further include a relation, an employee, a representative and/or an agent of originator 12 that facilitates method for recycling of scrap 10. The facilitation of method for recycling scrap 10 can include functions such as data input to website 16, packaging of scrap 20 in container 30 as well as those associated with assisting in the coordination with commercial carrier 24 for the pick-up of scrap 20.

Computer device 14 provides an interface for the transfer of data between originator 12 and website 16 that includes computer device 14 accessing recycling center website 16 using a browser and/or other similar software programs that support data transfer such as electronic mail that use the internet or other modes of wire and wireless data transfer. Computer device or computer 14 is a processor based device that interprets and executes instructions. Computer 14 can be any kind of processor based device to include for example a cellular phone, personal digital assistant, computer tablet, hand held computer, desktop computer, etc. that provides internet access and methods of data transfer such as electronic mail. Computer 14 is connectable to a printer for the production of a printed writing. For example, computer 14 can share data with, interface with and/or transfer data to another computer 14 that is associated with a printer. As shown in FIG. 1, originator 12 uses a keyboard/mouse/touch pad of device 14 to input data, but it is understood that the input of data to website 16 by computer 14 can be by any suitable technical means to include those being more increasingly employed such as touch screens, wands and verbal communications/voice recognition.

Website 16 provides a process for originator 12 to input and receive data for the shipment of scrap 20 to recycling center 18. Website 16 is hosted on a website server 34, interfaces with other website such as a website 22 of commercial carrier 24 and provides other functions as described herein to facilitate method for recycling scrap 10. The interface between computer 14 and website 16 can include computer 14 using a server to access the internet, website 16, and/or using electronic mail and/or other modes of data transfer between computer 14 and website 16. Website 16 has a pre-existing relationship with website 22 of commercial carrier 24 that includes the exchange of data, production and transfer of shipping label 26 and coordination of commercial carrier transportation 28.

The method for recycling scrap 10 can further include an initial screening and/or information exchange process prior to or in conjunction with the data input by originator 12. In this step, originator 12 initiates a communication with website 16 and/or directly with recycling center 18 on issues such as the acceptability of a given type of circuit board to the method for recycling scrap 10. The communication can include, for example, the exchange of an actual image of scrap 20 from originator 12 to website 16/recycling center 18.

Commercial carrier 24 can be any commercial transportation service provider for the shipment of scrap 20 to recycling center 18. Commercial carrier website 22 interfaces with website 16 to provide data such as the shipping cost charged by commercial carrier 24 for the transportation of scrap 20 between the location of scrap 20 and recycling center 18. Commercial carrier website 22 and/or website 16 can provide logic checks and feedback loops on the address of originator 12 and/or location of scrap 20. Commercial carrier 24 provides shipping label 26 which can include proprietary letters, numbers and/or scan readable formats such as bar codes. Commercial carrier transportation 28 is preferably ground transportation that can be advantageously scheduled for the convenience of originator 12 and/or reduced cost to pick-up from the location of scrap 20 and delivery of scrap 20 to recycling center 18.

Container 30 encloses scrap 20 during shipment by commercial carrier transportation 28. Container 30 is preferably a standard size container that is available through commercial carrier 24 or alternative sources of packaging. Container 30 provides a secure enclosure for scrap 20 during transportation 28. Container 30 is preferably a box type container made of materials such as cardboard suitable for the packaging and transportation 28 of scrap 20, but container 30 can also include alternative structural configurations and materials such as metals, composites, other forms of cellulose, polymers and combinations thereof. Container 30 can be flexible or rigid. In one example of alternative configurations, container 30 can include standard, reinforced or padded/insulated envelopes that meet the packaging requirements of commercial carrier 24.

Originator 12 uses computer 14 to input originator identifying data 36 to website 16 that includes data such as a name of an individual that is a point of contact, as appropriate a name of the company, an address, a telephone number and an e-mail address. Originator identifying data 36 provides data for the pick-up of scrap 20 by commercial carrier transportation 28 and payment 32 by recycling center 18. Website 16 can include well-known data integrity tests of originator identifying data 36 such as for example to ensure that the entered address and zip code correspond and/or is an existing known address. Website 16 can perform these tests automatically either using website 16 and/or external sources of data verification. Originator identifying data 36 can further include an electronic interface for payment 32 and a secondary address for when the location of scrap 20 is different from that of originator 12.

Originator 12 also uses computer 14 to select one or more types of scrap 20 from a list of acceptable scrap materials 38 on website 16. In the preferred embodiment, method for recycling scrap 10 restricts the type of scrap 20 for recycling to the types of scrap 20 specified in website 16 that are relatively high value electronic components such as select circuit boards and central processing units. Circuit boards, as defined herein, include both circuit card assemblies and motherboards, but can include additional types of specialized recyclable goods. Originator 12 inputs scrap data 40 into website 16 that includes the quantity of pieces of each type of scrap 20 and the total weight of each type of scrap 20.

Website 16 performs a scrap data value prediction 42 that is an assessment of whether the total value of the one or more types of scrap 20, as described by the scrap data 40, meets the requirements of the method for recycling scrap 10. Scrap data value prediction 42 calculates a predicted value of the one or more types of scrap data 40 using the input weight data per type of scrap data 40 and the value of each type of scrap 20 per pound. The value per pound of each type of scrap 20 can be a stored value in server 34 or a retrieved value from an external source that can be, for example, an internet website that publishes a current market value per pound of different types of scrap 20. Prediction 42 calculates the predicted total value of the one or more different types of scrap 20 based on the input scrap data 40. Website 16 can also include data integrity or logic checks that correlate the type, quantity and weight of the scrap data 40 to ensure scrap data 40 is consistent with known limitations of scrap 20.

When website 16 determines scrap data value prediction 42 is an unacceptable scrap data value prediction 44, website 16 provides feedback to originator 12 via computer 14 to resolve unacceptable prediction 44. Unacceptable scrap data value prediction 44 can be the result of, for example, weight minimums established by website 16 and limitations provided by commercial carrier 24 for transportation 28. Feedback to originator 12 can include, for example, a recommendation to add or reduce the weight of scrap 20 and corresponding scrap data 40 for one or more of the types of scrap 20. In this preferred embodiment, when website 16 determines an acceptable scrap data value prediction 46, website 16 preferably forwards originator 12 to define container 30.

Originator 12 also inputs container data 48 into website 16. In the preferred embodiment, container data 48 includes the approximate height, length and width dimensions of container 30. Alternatives include identifying a standard sized container from a list that can be from a commercial carrier or other sources with known dimensions. The website 16 includes an assessment of whether a container data is acceptable 50 for method for recycling scrap 10. The determination of whether container data is acceptable 50 includes evaluating whether input container data 48 is within the requirements of ground transportation 28 of commercial carrier 24.

As described previously for scrap data value prediction 42, the dimensional limitations for container 30 can be stored in server 34 or a retrieved value from an external source such as commercial carrier website 22. Container data acceptable 50 can include further tests to ensure the integrity of the type of the container 30 is consistent with the type, weight and quantity of scrap data 40. When website 16 determines the input container data 48 is unacceptable container data 52, website 16 provides feedback to originator 12 via computer 14 to resolve unacceptable container data 52. Feedback can include, for example, a recommendation to reduce one or more of the dimensions of container 30. When website 16 determines container data 48 is acceptable container data 54, website 16 forwards method for recycling scrap 10 to the next step.

Using the pre-existing relationship between website 16 and website 22 of commercial carrier 24, website 16 provides commercial carrier website 22 the location of scrap 20 identified in originator identification data 36 and the pre-existing location for recycling center 16 and requests a cost of commercial carrier transportation 56. Commercial carrier website 22 calculates the cost of ground transportation 28 and transfers the cost of commercial carrier transportation 52 to website 16.

In the preferred embodiment of website 16, the cost of commercial transportation or cost of transporting scrap 56 is provided automatically by website 16 based on a single source commercial carrier 20. The pre-existing relationship between recycling center 18 and commercial carrier 22 can include a preference to minimize the cost of commercial transportation 56 through criteria for the timing of the pick-up of scrap 20, priority or timeliness of commercial transportation 28 and timing of the delivery of scrap 20. This can include for example, scheduling the pick-up and/or drop off of scrap 20 using pre-existing scheduled deliveries of commercial carrier 24.

Website 16 can also include an option for shipping of scrap 20 by one of a plurality of commercial carriers 24. This can include website 16 automatically forwarding the pick-up and drop off locations to multiple commercial carriers 24 and evaluating the cost of commercial transportation 56 from each commercial carrier 24 and selecting the most economical commercial carrier 24 for scrap 20. Alternatively, for example, website 16 can provide originator 12 the option to select one commercial carrier 24 from a list of commercial carriers 24. In still another embodiment, website 16 accommodates into the cost of commercial carrier transportation 56 designating a preferred pick-up time of scrap 20.

Website 16 uses an algorithm to calculate whether a potential value of scrap data is acceptable 58 using acceptable scrap data value prediction 46 and the cost of commercial carrier transportation 56. Website 16 assesses whether the calculated potential value of scrap data is acceptable 58 passes a predefined threshold for profitability. The assessment of whether the potential value of scrap data is acceptable 58 determines the potential profitability of scrap 20 for recycling center 18.

If the calculation for whether the potential value of scrap data is acceptable 58 does not pass the predefined threshold and is determined by website 16 to be an unacceptable potential value of scrap data 60, website 16 provides feedback to originator 12 via computer 14 to resolve the unacceptable potential scrap data value 60. A determination of unacceptable potential value of scrap data 60 by website 16 can be the result of, for example, a disproportionate cost of commercial carrier transportation 56 relative to the acceptable scrap data value prediction 46. Feedback to originator 12 can include, for example, a recommendation to add or reduce the weight of scrap 20 and corresponding scrap data 40 for one or more of the types of scrap 20. If the calculation for whether the potential value of scrap data is acceptable 58 is determined by website 16 to be an acceptable potential value of scrap data 62, website 16 forwards originator 12 in method of recycling scrap 10.

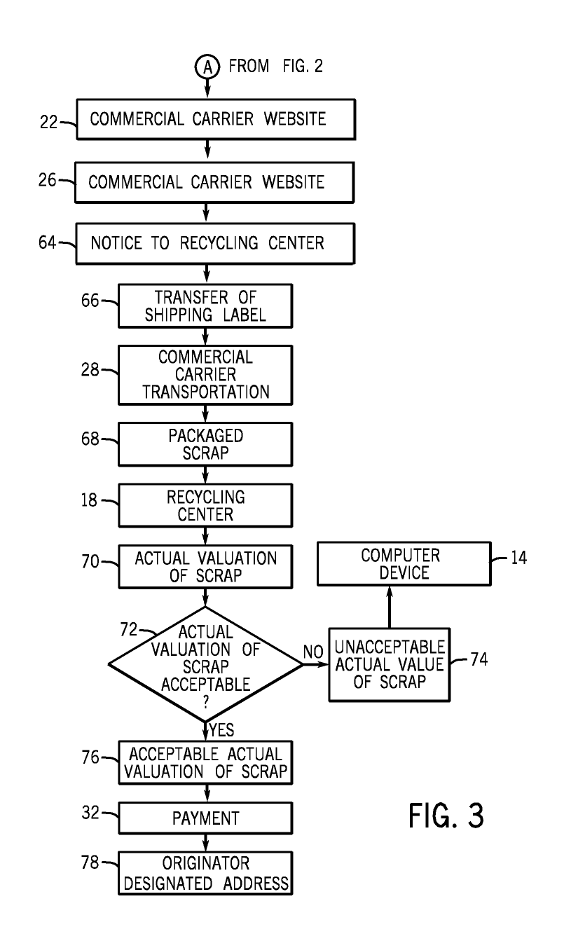

Referring now to FIGS. 1-3, when website 16 determines that there is an acceptable potential value of scrap data 62, website 16 authorizes commercial carrier website 22 to produce a shipping label 26. Commercial carrier 22 establishes the content of shipping label 26 that can typically include information associated with the pick-up, transfer and drop off of scrap 20 by commercial carrier transportation 28 such as a tracking number and an automated identifier such as a bar code, for example. Recycling center 18 preferably pre-populates select information such as the location of recycling center 18, priority of delivery and/or other limitations that relate to the bounding of the cost of commercial carrier transportation 56. Shipping label 26 is sized for attachment to container 30.

In one preferred embodiment, website 16 accommodates originator 12 specifying preferred pick-up times that can be, for example, coordinated with an ongoing daily or weekly delivery schedule by commercial carrier 24. Similarly, recycling center 18 can pre-order any delivery schedule of scrap 20, but prefers the delivery of scrap 20 in coordination with existing delivery schedules and/or at the convenience of commercial carrier 24 to recycling center 18. As one example, recycling center 18 can pre-populate shipping label 26 for a relatively low priority for local transportation that could include “next day” type delivery without a specified time of arrival and/or at the convenience of commercial carrier transportation 28 due to the ongoing work operations at recycling center 18.

Website 16 preferably automatically requests shipping label 26 be provided by commercial carrier 24 and/or website 22 upon the determination of the acceptable potential value of scrap data 62. In addition, upon the determination of the acceptable potential value of scrap data 62, website 16 also requests website 22 provide a notice 64 to recycling center 18 of the production of shipping label 26 for originator 12. Notice 64 is in the form of a communication to recycling center 18 that is preferably sent to a computer associated with recycling center 18 that can include server 34. The communication of notice 64 can take any form to include electronic mail, text, etc. Notice 64 informs recycling center 18 of the utilization of the method for recycling scrap 10 by commercial carrier 24. Notice 64 can also include scrap data 40 information such as the time of delivery, quantity, and weight of each type of scrap 20 that can assist recycling center 18 for any preparations that may be required to receive and process scrap 20.

A transfer of shipping label 66 to originator 12 can be performed by any means of data transfer. Website 16 preferably authorizes commercial carrier 24 to perform the transfer of shipping label 66 via electronic communication such as electronic mail that is accessible by computer device 14. Alternatively, website 16 can receive and provide for the transfer of shipping label 66 to originator 12 using standard data transfer means that include for example downloading from website 16, facsimile and electronic mail.

Commercial carrier transportation 28 picks-up a packaged scrap 68 from the location designated by originator 12 as a location of scrap 20. Packaged scrap 68 as defined herein is scrap 20 appropriately packaged in container 30 with shipping label 26 attached to container 30. Packaged scrap 68 is transferred by commercial carrier transportation 28 to recycling center 18.

At recycling center 18, scrap 20 undergoes an assessment that includes a calculation using an algorithm to determine the actual valuation of scrap 70 that is independent of website 16. The calculation for actual valuation of scrap 70 can be made on any type of computer to include server 34 or another computer that can provide an algorithm based computation such as a hand held computer. In one preferred embodiment, the computer is a laptop or desktop type computer located at recycling center 18. The determination of the actual valuation of scrap 70 includes the weighing and counting of the quantity of each type of the one or more types of scrap 20 that arrived at recycling center 18 in container 30. This actual data on scrap 20 is then used in combination with the current actual value of each type of scrap 20 per pound in the algorithm. The current actual value of each type of scrap 20 can be identified by using data from existing written or internet based sources accessible to the computer. Actual valuation of scrap 70 includes evaluating the actual calculated value of scrap 20 relative to the cost of commercial transportation 56 to determine whether the actual valuation of scrap is acceptable 72. The algorithm for whether the actual value of scrap is acceptable 72 is the basis for determining the payment 32 to originator 12 and the profitability or benefit of scrap 20 for recycling center 18.

If the actual value of scrap is acceptable 72 does not pass a predefined threshold and is determined to be unacceptable actual valuation of scrap 74, recycling center 18 provides feedback to originator 12 via computer device 14 as described previously or as an alternate form of payment 32 of the unacceptable actual valuation of scrap 74. Unacceptable actual valuation of scrap 74 can be the result of, for example, errors in scrap data 40 and/or disproportionate cost of commercial carrier transportation 56.

If the calculation for whether the actual valuation of scrap data is acceptable 72 passes the predefined threshold and is determined to be an acceptable actual valuation of scrap 76, recycling center processes scrap 20 for recycling. Whether scrap 20 is determined to be acceptable actual valuation of scrap 76 or unacceptable actual valuation of scrap 74, scrap 20 is processed for recycling by recycling center 18 in an environmentally responsible manner.

When the calculation determines the actual valuation of scrap data is acceptable 76, recycling center 18 quantifies the amount of payment 32 to originator 12 and profitability for recycling 18 based on the algorithm calculation. Payment 32 can be forwarded to originator 12 via any means to include the United States Postal Service, commercial carrier 24 or via data transfer to the account designated by originated 12 in originator identification data 36. In the preferred embodiment, payment 32 is a written check to originator 12 that is sent to an originator designated address 78 listed in originator identification data 36 that can be the same or a different location than that of the pick-up of scrap 20.

The pre-existing relationship between recycling center 18 and commercial carrier 24 directs the billing for the commercial carrier transportation 28 of scrap 20 to recycling center 18. Recycling center 18 pays the cost of commercial transportation 56 per the defined pre-existing relationship with commercial carrier 24. This can include for example the invoicing of recycling center 18 for each commercial carrier transportation 28 transaction or recycling center maintaining a designated amount in a deposit account for commercial carrier 24.

In the preceding specification, the present disclosure has been described with reference to specific exemplary embodiments thereof. It will be evident, however, that various modifications, combinations and changes may be made thereto without departing from the broader spirit and scope of the invention as set forth in the claims that follow. For example, while the method described herein is described in terms recycling scrap 20, it can be understood that this method can be used in alternative commercial activities. Further, it is understood that the sequence of the above steps for the method for recycling scrap 10 such as the inputting of data to website 16 for user identification 32, material to be recycled 34 and container 24 can be altered in sequence and/or merged into a single step without altering the present disclosure. In addition, though the present invention is described in terms of a series of embodiments, each embodiment of the present invention can combine one or more novel features of the other embodiments. The specification and drawings are accordingly to be regarded in an illustrative manner rather than a restrictive sense.

What is claimed is:

1. A method for recycling scrap comprising the steps of:
a) using a computer device for inputting data into a website of a recycling center, the inputting of data including data on
1) an originator of scrap,
2) scrap, the website limiting the inputting of data on scrap to one or more types of scrap, and
3) a container, the container providing packaging for the scrap during the transportation of the scrap;
b) calculating whether a potential value of the scrap data is acceptable using the scrap data and a cost of transporting the scrap by a commercial carrier;
c) determining whether the potential value of the scrap data is acceptable;
d) authorizing the preparation of a shipping label by the commercial carrier when the calculation of whether the potential value of the scrap data is acceptable determines an acceptable potential value of scrap data;
e) transporting the scrap using the commercial carrier from a location of the scrap to a location of the recycling center, the scrap packaged in the container, the shipping label attached to the container;
f) calculating an actual valuation of the scrap; and
g) providing a payment from the recycling center to the originator based on the actual valuation of the scrap.

2. The method for recycling scrap of claim 1, wherein the step of inputting data on the scrap includes inputting a type of scrap from a list of one or more types of scrap, a quantity of each type of scrap and a weight of each type of scrap.

3. The method for recycling scrap of claim 1, wherein the step of calculating the potential value of scrap data includes the website interfacing with a commercial carrier for the cost of transporting the scrap from the location of the scrap to the location of the recycling center and evaluating the cost of transporting the scrap by the commercial carrier relative to the potential value of the scrap.

4. The method for recycling scrap of claim 3, wherein the step of calculating the potential value of scrap data includes the website automatically interfacing with a commercial carrier for the cost of transporting the scrap.

5. The method for recycling of scrap of claim 1, wherein the step of determining whether the potential value of the scrap data is acceptable includes not authorizing the preparation of a shipping label when the potential value of the scrap data is determined unacceptable.

6. The method for recycling scrap of claim 1, wherein the step of performing an actual valuation includes identifying the one or more actual types of scrap, determining the actual quantity of scrap pieces and the actual weight of the one or more types of scrap and calculating the actual value of the scrap at the recycling center.

7. The method for recycling scrap of claim 6, wherein the step of calculating an actual valuation includes determining a benefit to the recycling center of the scrap by evaluating the cost of transporting the scrap to the recycling center relative to the actual valuation of the scrap.

8. The method for recycling scrap of claim 1, wherein the step of inputting data on a container includes inputting the dimensions of the container.

9. The method for recycling scrap of claim 1 wherein including the step of authorizing further includes sending a notice to the recycling center of the authorizing of the shipping label.

10. A method for shipping scrap from a location for recycling, the method comprising the steps of:
a) using a computer device for inputting data into a website of a recycling center on
1) an originator of scrap,
2) scrap, the data on scrap including a weight and a quantity of each type of scrap, the website limiting the inputting of data to one or more defined types of scrap, and
3) a container, the container providing packaging for the scrap during the transportation of the scrap;
b) calculating whether a scrap data value prediction is acceptable using the data input into the website on the scrap and determining if the scrap data value prediction is an acceptable scrap data value prediction;
c) acquiring a cost for the transporting the scrap when the predicted value of the scrap is acceptable, the cost of transporting the scrap including the cost of transporting the scrap by a commercial carrier from the location of the scrap to a location of the recycling center, the location of the scrap included in the data input into the website;
d) calculating a potential value of the scrap data after an acceptable scrap data value prediction, the calculating of the potential value including evaluating the acceptable scrap data value prediction relative to the cost for the transporting the scrap;
e) determining whether the potential value of the scrap data provides an acceptable potential value to the recycling center;
f) authorizing the preparation of a shipping label by the commercial carrier when the calculation of the potential value of the scrap data determines an acceptable potential value of scrap data and providing for a transfer of the shipping label to the originator;
g) using the commercial carrier for the transporting of the scrap from the location of the scrap to a location of the recycling center, the scrap packaged in the container, the shipping label attached to the container;
h) calculating an actual valuation of the scrap and determining a benefit of the scrap to the recycling center; and
i) providing a payment from the recycling center to the originator based on the actual valuation of the scrap.

11. The method for recycling scrap of claim 10, wherein the step of inputting data on the scrap includes inputting a type of scrap from a list of one or more types of scrap, a quantity of each type of scrap and a weight of each type of scrap.

12. The method for recycling scrap of claim 10, wherein the step of inputting data on a container includes inputting data that includes the dimensions of the container.

13. The method for recycling scrap of claim 10, wherein the step of calculating a potential value of the scrap data includes the website receiving a cost for transporting the scrap from a commercial carrier.

14. The method for recycling scrap of claim 10, wherein the cost of transporting the scrap includes the website selecting a lowest cost commercial carrier from the costs received by the website from a plurality of commercial carriers.

15. The method for recycling scrap of claim 10, wherein the cost of transporting the scrap includes the website interfacing automatically with a single commercial carrier for the cost of transporting the scrap.

16. The method for recycling scrap of claim 10, wherein the step of calculating the potential value of scrap data includes the website selecting one source of transportation from a plurality of sources of transportation for the scrap, the selected source of transportation delivering the scrap to the recycling center in the least amount of time.

17. The method for recycling scrap of claim 10, wherein the step of authorizing the preparation of a shipping label includes sending notice to the recycling center of the authorizing of the shipping label.

18. The method for recycling scrap of claim 17, wherein the notice further includes the data input on the type, weight and quantity of scrap.

19. The method of recycling scrap of claim 10, wherein the inputting of data further includes inputting an image of the scrap.

20. The method for recycling scrap of claim 19, wherein the image of the scrap is reviewed by the recycling center to determine whether the scrap is acceptable for recycling using the website of the recycling center.
